(19) United States
(12) Patent Application Publication
(10) Pub. No.: US 2024/0044357 A1
(43) Pub. Date: Feb. 8, 2024

(54) COOKING APPLIANCE

(71) Applicant: SAMSUNG ELECTRONICS CO., LTD., Suwon-si (KR)

(72) Inventors: Sangwon YUN, Suwon-si (KR); Sangjin JEONG, Suwon-si (KR); Seokang KIM, Suwon-si (KR)

(73) Assignee: SAMSUNG ELECTRONICS CO., LTD., Suwon-si (KR)

(21) Appl. No.: 18/381,746

(22) Filed: Oct. 19, 2023

Related U.S. Application Data
(63) Continuation of application No. PCT/KR2022/095087, filed on Apr. 14, 2022.

(30) Foreign Application Priority Data
May 4, 2021 (KR) 10-2021-0058017
Jun. 10, 2021 (KR) 10-2021-0075306

(51) Int. Cl. F16B 43/00; H05B 6/64

(52) U.S. Cl. CPC F16B 43/00; H05B 6/6429

(57) ABSTRACT

A cooking apparatus including a main body having a cooking chamber inside the main body; a mounting bolt; and a holder. The mounting bolt includes a bolt head, and a bolt body extending from the bolt head and configured to sequentially penetrate an external structure to which the cooking apparatus is to be mounted and the main body. The holder is detachably coupleable to the mounting bolt so that, when the holder is coupled to the mounting bolt with the bolt body penetrating the external structure and the main body, the holder is outside of the main body and supports the mounting bolt. The holder includes a holder body configured to separate the bolt head and the external structure and to adjust a protruding length of the bolt body into the main body; and an elastic support part inside the holder body and configured to elastically support the bolt body.

### CROSS-REFERENCE TO RELATED APPLICATIONS

This application is a continuation of International Application PCT/KR2022/095087, filed Apr. 14, 2022, which is incorporated herein by reference in its entirety, and claims priority to Korean Applications 10-2021-0058017, filed May 4, 2021, and 10-2021-0075306, filed Jun. 10, 2021, which are incorporated herein by reference in their entireties.

### BACKGROUND

### 1. Field

The present disclosure relates to a cooking apparatus. More particularly, the present disclosure relates to a cooking apparatus capable of being fixed to an external structure.

### 2. Description of Related Art

A cooking apparatus is an apparatus for cooking by heating a cooking object such as food, and refers to an apparatus capable of providing various functions related to cooking, such as heating, thawing, drying, and sterilization of a cooking object. As such a cooking apparatus, there are, for example, an oven such as a gas oven and an electric oven, a microwave heating device (hereinafter referred to as a microwave oven), a gas range, an electric range, a microwave oven combined with a hood (Over the Range), a gas grill or an electric grill, and the like.

The Over the Range is a microwave oven with a hood function that is responsible for ventilation in a kitchen, and an installation space is minimized while cooking food more conveniently and efficiently. This Over the Range may be located above a cooking apparatus such as a gas range and cooktop.

In particular, the Over the Range may be installed in a storage cabinet (cupboard) provided on an upper side of a kitchen space. In this case, a thickness of the storage cabinet is not standardized and is generally not constant. Accordingly, a length of a fixing bolt for fixing the Over the Range and the storage cabinet is being designed to be long so that the fixing bolt may be used even when the storage cabinet is thick. However, when the thickness of the cabinet is thin, there is a possibility that the long fixing bolt interferes with internal components of the Over the Range.

In addition, in order to avoid interference between the fixing bolt and the internal components of the Over the Range (e.g., an internal structure and electronic components), a separate and cumbersome task of moving a position of the fixing bolt or positions of the internal components may be involved.

### SUMMARY

According to an embodiment of the present disclosure, a cooking apparatus may include a main body having a cooking chamber inside the main body; and a mounting bolt including a bolt head, and a bolt body extending from the bolt head and configured to sequentially penetrate an external structure to which the cooking apparatus is to be mounted and then the main body; and a holder detachably coupleable to the mounting bolt so that, when the holder is coupled to the mounting bolt with the bolt body penetrating the external structure and the main body, the holder is outside of the main body and supports the mounting bolt, wherein the holder includes a holder body configured to, when the holder is coupled to the mounting bolt with the bolt body penetrating the external structure and the main body, separate the bolt head and the external structure and, when separating the bolt head and the external structure, to adjust a protruding length of the bolt body into the main body, and an elastic support part inside the holder body and configured to, when the holder is coupled to the mounting bolt, elastically support the bolt body.

According to an embodiment of the present disclosure, the elastic support part of the holder may include an elastic support part body, a hollow portion formed inside the elastic support part body to accommodate the mounting bolt when the holder is coupled to the mounting bolt, and a plurality of elastic pieces formed to have elasticity by cutting out the elastic support part body.

According to an embodiment of the present disclosure, each of the plurality of elastic pieces may include a pressing surface configured to press an outer circumferential surface of the bolt body when the holder is coupled to the mounting bolt, a first inclined surface formed to be away from the bolt body from one end of the pressing surface when the holder is coupled to the mounting bolt, and a second inclined surface formed to be away from the bolt body from an other end of the pressing surface when the holder is coupled to the mounting bolt.

According to an embodiment of the present disclosure, the holder body may be a first holder body, and the holder may further include a second holder body extending from the first holder body and having an accommodation portion therein to accommodate the mounting bolt when the holder is coupled to the mounting bolt.

According to an embodiment of the present disclosure, the holder may be configured to be detachably coupleable to the mounting bolt by passing through a lower end of the bolt body and being pushed up toward the bolt head.

According to an embodiment of the present disclosure, the holder may be coupleable to the mounting bolt in a first state or a second state, the first holder body may be adjacent to the bolt head while the holder is coupled to the mounting bolt in the first state, and the bolt head may be accommodated in the accommodation portion of the second holder body while the holder is coupled to the mounting bolt in the second state.

According to an embodiment of the present disclosure, the protruding length of the bolt body into the main body while the holder is coupled to the mounting bolt in the first state may be smaller than the protruding length of the bolt body into the main body while the holder is coupled to the mounting bolt in the second state.

According to an embodiment of the present disclosure, the bolt head may be configured to be supported by an upper surface of the first holder body while the holder is coupled to the mounting bolt in the first state, and the bolt head may be configured to be accommodated in the accommodation portion of the second holder body while the holder is coupled to the mounting bolt in the second state.

According to an embodiment of the present disclosure, the bolt body may have screw threads, and a length of the pressing surface may be longer than a pitch of the screw threads of the bolt body.

According to an embodiment of the present disclosure, the bolt body may have screw threads, and the mounting bolt may further include an unthreaded portion extending from a lower end of the bolt body, having a diameter smaller than that of the bolt body.

According to an embodiment of the present disclosure, a bottom surface of the holder body and a bottom surface of the elastic support part may be on a same plane so that, when the holder is coupled to the mounting bolt with the bolt body penetrating the external structure and the main body, the holder stably supports the mounting bolt with respect to the external structure.

According to an embodiment of the present disclosure, the cooking apparatus may further include a base plate configured to draw air from a lower portion of the main body, and a filter configured to filter out foreign substances in the air drawn from the base plate.

According to an embodiment of the present disclosure, the hollow portion may include a section in which, when the holder is coupled to the mounting bolt, a diameter of the hollow portion decreases from a first side adjacent to the bolt head toward a second side adjacent to a lower end of the bolt body.

According to an embodiment of the present disclosure, the cooking apparatus may further include a support bracket positionable adjacent to an inner surface of the main body so that, when the support bracket is positioned adjacent to the inner surface of the main body and the bolt body penetrates the main body, the bolt body penetrates through the support bracket, a mounting nut coupleable with the bolt body penetrated through the support bracket, and a spring holder coupled to the support bracket to support the mounting nut.

According to an embodiment of the present disclosure, a cooking apparatus, which is capable of being fixed to an external structure, may include a cabinet, a mounting bolt including a bolt head and a bolt body provided to sequentially penetrate the external structure and the cabinet of the cooking apparatus while the cabinet is fixed to the external structure, and a holder provided to be detachably coupled to the mounting bolt so as to adjust a protruding length of the bolt body of the mounting bolt into the cabinet, wherein the holder includes a first holder body having a first height, a second holder body extending from a first end of the first holder body and having a second height, and an elastic support part provided inside the first holder body to extend along an extension direction of the first holder body, the elastic support part being provided to elastically support the bolt body of the mounting bolt.

According to an embodiment of the present disclosure, the holder may be capable of being coupled to the mounting bolt in a first state or a second state, the first holder body may be adjacent to the bolt head while the holder is coupled to the mounting bolt in the first state, and the second holder body may be adjacent to the bolt head while the holder is coupled to the mounting bolt in the second state.

According to an embodiment of the present disclosure, the elastic support part of the holder may include an elastic support part body, a hollow portion formed inside the elastic support part body to accommodate the bolt body, and a plurality of elastic pieces formed to have elasticity by cutting out the elastic support part body.

According to an embodiment of the present disclosure, each of the plurality of elastic pieces may include a pressing surface provided to press an outer circumferential surface of the bolt body, a first inclined surface formed to be away from the bolt body from one end of the pressing surface, and a second inclined surface formed to be away from the bolt body from the other end of the pressing surface.

According to an embodiment of the present disclosure, a fastening device, which is capable of being used to fix a cooking apparatus to an external structure, may include a mounting bolt including a bolt head and a bolt body provided to extend from the bolt head so as to sequentially penetrate the external structure and a cabinet of the cooking apparatus, and a holder detachably coupled to the mounting bolt so as to prevent the bolt body penetrated through the cabinet of the cooking apparatus from interfering with electronic components or internal structures accommodated in the cooking apparatus, wherein the holder includes a holder body provided to separate the bolt head and the external structure by a predetermined distance, and an elastic support part provided inside the holder body to elastically support the bolt body of the mounting bolt.

According to an embodiment of the present disclosure, the elastic support part may further include at least one elastic piece formed by a slot to have elasticity, and the at least one elastic piece may be provided to press an outer circumferential surface of the bolt body.

### BRIEF DESCRIPTION OF THE DRAWINGS

FIG. 1 is a perspective view illustrating a state in which a cooking apparatus according to an embodiment of the present disclosure is installed.

FIG. 2 is a perspective view of the cooking apparatus shown in FIG. 1.

FIG. 3 is an exploded perspective view of the cooking apparatus shown in FIG. 1.

FIG. 4 is a perspective view of a fastening device according to an embodiment of the present disclosure.

FIG. 5 is an exploded perspective view of the fastening device shown in FIG. 4.

FIG. 6 is a cross-sectional view of the fastening device shown in FIG. 4.

FIG. 7 is an enlarged view of part B shown in FIG. 4.

FIG. 8 is a bottom perspective view of a holder of the fastening device shown in FIG. 4.

FIG. 9 is a bottom view of the holder shown in FIG. 8.

FIG. 10 is a view schematically illustrating a state in which the cooking apparatus is fixed to an external structure when a thickness of the external structure is thin.

FIG. 11 is an enlarged cross-sectional view of part C shown in FIG. 10.

FIG. 12 is a view schematically illustrating a state in which the cooking apparatus is fixed to the external structure when a thickness of the external structure is thick.

FIG. 13 is an enlarged cross-sectional view of part D shown in FIG. 12.

FIG. 14 is a perspective view illustrating a part of the fastening device according to an embodiment of the present disclosure.

FIG. 15 is a bottom perspective view of FIG. 14.

FIG. 16 is a perspective view of a fastening device according to another embodiment of the present disclosure.

FIG. 17 is a view illustrating that a holder according to another embodiment of the present disclosure is being coupled to a mounting bolt in a first state.

FIG. 18 is a view illustrating that the holder according to another embodiment of the present disclosure is being coupled to the mounting bolt in a second state.

FIG. 19 is a view illustrating a state in which the cooking apparatus is fixed to the external structure through the fastening device according to another embodiment of the present disclosure.

FIG. 20 is an enlarged cross-sectional view of part E shown in FIG. 19.

FIG. 21 is a view illustrating a state in which the cooking apparatus is fixed to the external structure through the fastening device according to another embodiment of the present disclosure.

FIG. 22 is an enlarged cross-sectional view of part F shown in FIG. 21.

FIG. 23 is a cross-sectional view of the fastening device while a holder is coupled to the mounting bolt in the first state according to another embodiment of the present disclosure.

FIG. 24 is a cross-sectional view of the fastening device while the holder is coupled to the mounting bolt in the second state according to another embodiment of the present disclosure.

### DETAILED DESCRIPTION

The embodiments described in the present specification and the configurations shown in the drawings are only examples of preferred embodiments of the present disclosure, and various modifications may be made at the time of filing of the present disclosure to replace the embodiments and drawings of the present specification.

Like reference numbers or signs in the various drawings of the application represent parts or components that perform substantially the same functions.

The terms used herein are for the purpose of describing the embodiments and are not intended to restrict and/or to limit the present disclosure. For example, the singular expressions herein may include plural expressions, unless the context clearly dictates otherwise. Also, the terms “comprises” and “has” are intended to indicate that there are features, numbers, steps, operations, components, parts, or combinations thereof described in the specification, and do not exclude the presence or addition of one or more other features, numbers, steps, operations, components, parts, or combinations thereof.

It will be understood that, although the terms first, second, etc. may be used herein to describe various components, these components should not be limited by these terms, and the terms are only used to distinguish one component from another. For example, without departing from the scope of the present disclosure, a first component may be referred to as a second component, and similarly, the second component may also be referred to as a first component. The term “and/or” includes any combination of a plurality of related items or any one of a plurality of related items.

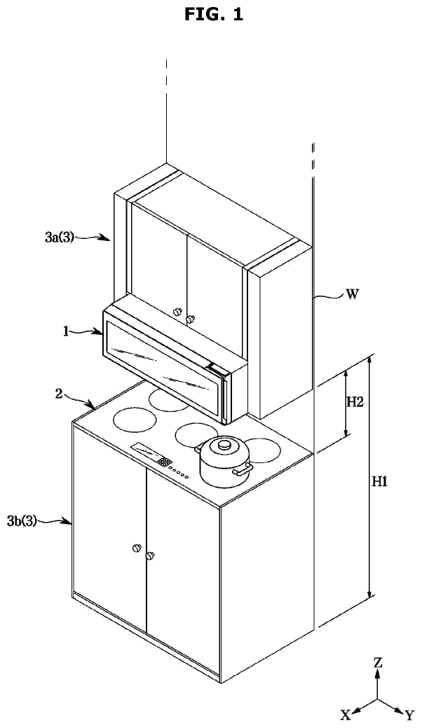

In this specification, the terms “up-down direction,” “left-right direction,” “front-rear direction,” “upper portion,” “lower portion,” “upper side” and “lower side ” used in the following description are defined with reference to the drawings, and the shape and position of each component are not limited by these terms. For example, based on FIG. 1, a Z direction may be defined as an up-down direction, a Y direction may be defined as a left-right direction, and an X direction may be defined as a front-rear direction.

According to various embodiments of the present disclosure, a cooking apparatus is capable of preventing interference between a fastening device and internal components of the cooking apparatus.

According to various embodiments of the present disclosure, a cooking apparatus capable of securing performance, reducing design time, and reducing installation time can be provided.

Hereinafter, embodiments of the present disclosure will be described in detail with reference to the accompanying drawings.

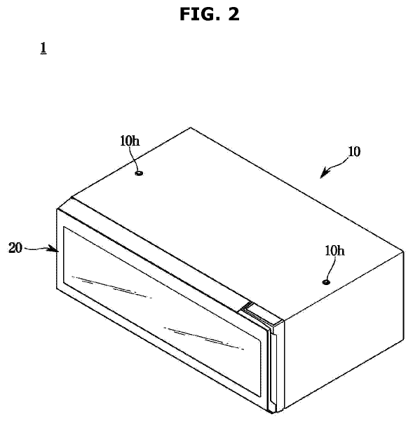

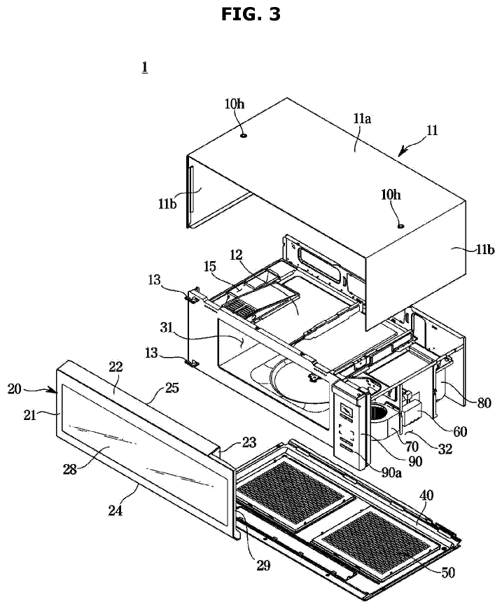

FIG. 1 is a perspective view illustrating a state in which a cooking apparatus according to an embodiment of the present disclosure is installed. FIG. 2 is a perspective view of the cooking apparatus shown in FIG. 1. FIG. 3 is an exploded perspective view of the cooking apparatus shown in FIG. 1.

Referring to FIG. 1, a first cooking apparatus 1 and a second cooking apparatus and 2 may be disposed indoors. The first cooking apparatus 1 and the second cooking apparatus 2 may be disposed in a kitchen.

The first cooking apparatus 1 and the second cooking apparatus 2 may be installed on an external structure 3. The external structure 3 may include an upper storage cabinet 3a provided on an upper side of a kitchen space and a lower storage cabinet 3b provided on a lower side of the kitchen space. The external structure referred to in this specification may collectively refer to all a storage cabinet, a drawer, a cupboard, a wall W, and the like.

The first cooking apparatus 1 may be installed in the upper storage cabinet 3a. The second cooking apparatus 2 may be installed below the first cooking apparatus 1 by being spaced apart from the first cooking apparatus 1 by a predetermined distance H2. For example, the second cooking apparatus may be installed in the lower storage cabinet 3b.

The first cooking apparatus 1 may be disposed above the second cooking apparatus 2. The first cooking apparatus 1 may draw and discharge exhaust gas, smoke, food odor, and the like generated in the second cooking apparatus 2 to the outside. For example, the first cooking apparatus 1 may perform a hood function. However, the function of the first cooking apparatus 1 is not limited thereto, and the first cooking apparatus 1 may cook food with high frequency waves through a magnetron or cook food through a heater.

The first cooking apparatus 1 may be installed at a predetermined height H1 from a floor. In this case, the first cooking apparatus 1 may be installed at the appropriate height H1 suitable for a height or an eye height of a user so that the user may easily operate the first cooking apparatus 1. For example, when the first cooking apparatus 1 is a microwave oven, the first cooking apparatus 1 may be an Over the Range (OTR) capable of performing the hood function.

Hereinafter, the first cooking apparatus 1 will be described in more detail. The first cooking apparatus 1 will be referred to as a cooking apparatus.

Referring to FIGS. 2 and 3, the cooking apparatus 1 may include a main body 10. The main body 10 may be provided to protrude more forward than the external structure 3. However, the present disclosure is not limited thereto, and the main body 10 may be provided not to protrude more forward than the external structure 3.

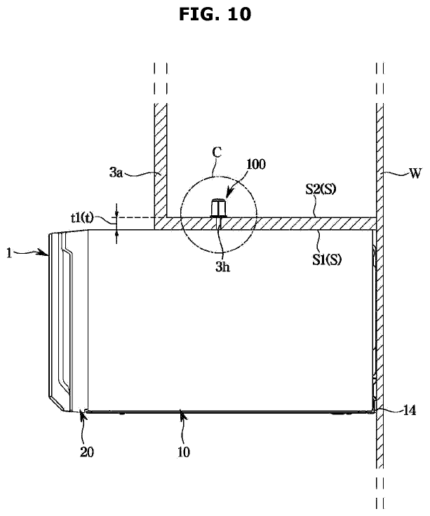

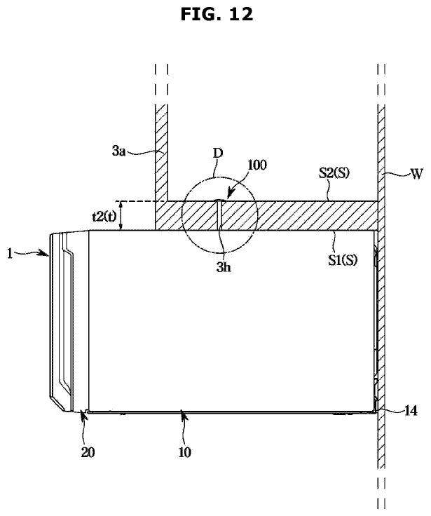

The main body 10 of the cooking apparatus 1 may be fixed to the external structure 3. The main body 10 of the cooking apparatus 1 may be fixed to the upper storage cabinet 3a. The main body 10 of the cooking apparatus 1 may be installed in an installation part S of the upper storage cabinet 3a (see FIGS. 10 and 12). The installation part S may form a bottom of the upper storage cabinet 3a. The installation part S may be provided to have a predetermined thickness t. The installation part S may include a first surface S1 facing the cooking apparatus 1, and a second surface S2 positioned on an opposite side of the first surface S1 to face the inside of the upper storage cabinet 3a. Also, the installation part S may include a first passing hole 3h formed to penetrate the first surface S1 and the second surface S2. A plurality of the first passing holes 3h may be provided. The first passing hole 3h may be a hole through which a bolt body 112 of a mounting bolt 110, which will be described later, may pass. The first passing hole 3h may be provided at a position corresponding to a second passing hole 10h of the main body 10, which will be described later.

The main body 10 may include cabinets 11 and 12. The cabinets 11 and 12 may include an outer case 11 and an inner case 12. The outer case 11 may be provided to accommodate internal components for penetrations of the inner case 12 and the cooking apparatus 1. For example, the outer case 11 may form an exterior of the main body 10. For example, the outer case 11 may include a top plate 11a and side plates 11b.

The cooking apparatus 1 may include a door 20. The door 20 may be provided in front of the main body 10. The door 20 may be rotatably provided on the main body 10 to open and close a cooking chamber 31. For example, the door 20 may be coupled to the main body 10 by a hinge 13. However, a coupling method of the main body 10 and the door 20 is not limited to the above example. The door 20 may be provided in a shape corresponding to a front side of the main body 10. For example, the door 20 may include a front panel 21, an upper panel 22, side panels 23, a lower panel 24, and a rear panel 25. The door 20 may include a transparent part 28 and a handle 29. The transparent part 28 may allow the user to check a cooking state of food in the cooking chamber 31. The handle 29 may be provided such that the user may grip the door 20.

The cooking apparatus 1 may perform the hood function. The cooking apparatus 1 may include a base plate 40 provided below the main body 10. The base plate 40 may be provided to draw air. The base plate 40 may include intake holes (not shown). The base plate 40 may draw exhaust gas, smoke, food odor, and the like generated in the kitchen space. The base plate 40 may form a bottom surface of the cooking apparatus 1.

A filter 50 may be coupled to the base plate 40. The filter 50 may be disposed to correspond to the intake holes (not shown) of the base plate 40. The filter 50 may filter out foreign substances contained in air, smoke, and the like discharged from the second cooking apparatus 2.

The main body 10 may include the second passing hole 10h such that the mounting bolt 110 of a fastening device 100, which will be described later, may pass through the outer case 11 therethrough. For example, the second passing hole 10h may be formed on the top plate 11a of the outer case 11. A plurality of the second passing holes 10h may be provided. The second passing hole 10h may be provided at a position corresponding to the passing hole 3h of the installation part S.

The cooking apparatus 1 may include the cooking chamber 31. The cooking chamber 31, which is a space for cooking food, may be provided inside the main body 10. Specifically, the cooking chamber 31 may be provided within the inner case 12.

The cooking apparatus 1 may include a control panel 85 provided with an operation button 85a capable of controlling a cooking operation of food. The cooking apparatus 1 may include a magnetron (not shown) generating high frequency waves and/or a heater (not shown) generating heat. The cooking apparatus 1 may further include a holding part (not shown) disposed at a lower portion of the cooking chamber 31 to hold food.

The cooking apparatus 1 may include internal components provided inside the main body 10. The internal components may be provided for an operation of the cooking apparatus 1 (e.g., food cooking, air intake, air discharge, etc.). For example, the internal components may include electronic components and internal structures provided for arranging the electronic components. However, the present disclosure is not limited thereto, and the internal components may refer to various components provided inside the outer case 11 of the main body 10.

The cooking apparatus 1 may include electronic components disposed within the outer case 11. The electronic components may include a controller 60 and a radiating fan 70. For example, the controller 60 and the radiating fan 70 may be disposed in an electronical component room 32. The electronical component room 32, which is a space separated from the cooking chamber 31, may be disposed on one side of the cooking chamber 31. The controller 60 and the radiating fan 70 may be disposed outside the inner case 12. The controller 60 and the radiating fan 70 may be disposed between the inner case 12 and the outer case 11. The controller 60 may control an intensity or strength of the magnetron and/or heater. The controller 60 may adjust rotation speeds of the radiating fan 70 and a fan 80. The radiating fan 70 may radiate heat generated from the controller 60. Through this, the controller 60 may be less likely to fail without overheating.

The cooking apparatus 1 may include the fan 80. The fan 80 may be disposed at a side and/or rear of the cooking chamber 31. A plurality of the fans 80 may be provided. The fan 80 may be provided such that air flowing inside the main body 10 flows smoothly. The fan 80 may assist in intake and/or discharge of air into and/or from the cooking apparatus 1. For example, the fan 80 may be disposed adjacent to the intake holes (not shown) of the base plate 40. The fan 80 may be disposed on a flow path through which air flows. However, the position of the fan 80 is not limited thereto.

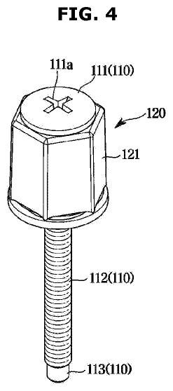

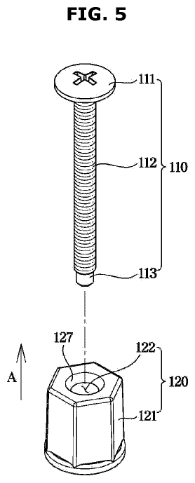

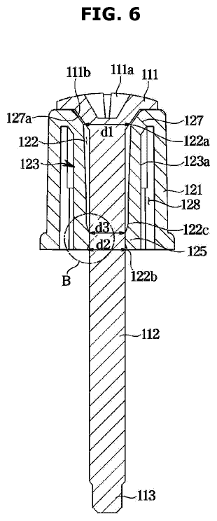

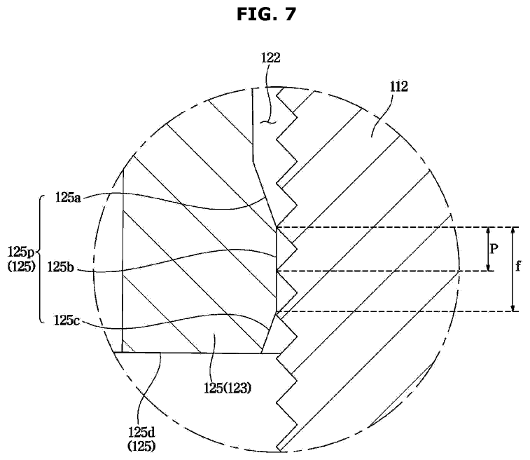

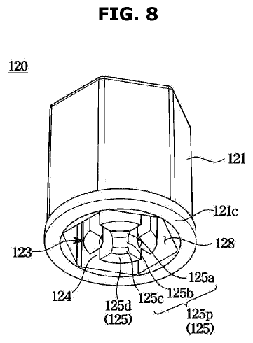

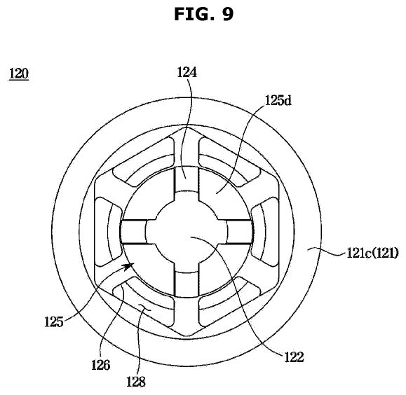

FIG. 4 is a perspective view of a fastening device according to an embodiment of the present disclosure. FIG. 5 is an exploded perspective view of the fastening device shown in FIG. 4. FIG. 6 is a cross-sectional view of the fastening device shown in FIG. 4. FIG. 7 is an enlarged view of part B shown in FIG. 4. FIG. 8 is a bottom perspective view of a holder of the fastening device shown in FIG. 4. FIG. 9 is a bottom view of the holder shown in FIG. 8.

The fastening device 100 may be used to fix a home appliance to an external structure. For example, home appliances may include a cooking apparatus, an air conditioner, a refrigerator, and the like, but are not limited to these examples. Hereinafter, the fastening device 100 will be described as an example used for fixing the main body 10 of the cooking apparatus 1 to the external structure 3.

The fastening device 100 may include the mounting bolt 110 and a holder 120. The holder 120 may be detachably coupled to the mounting bolt 110.

The mounting bolt 110 may include a bolt head 111 and the bolt body 112.

A groove 111a may be provided on an upper surface of the bolt head 111 to facilitate coupling with a tool (e.g., a screwdriver). The drawing illustrates that the groove 111a has a cross shape, but is not limited thereto.

The bolt body 112 may extend from the bolt head 111. The bolt body 112 may have a smaller diameter than that of the bolt head 111.

The bolt body 112 may be provided to penetrate the cabinet 11 of the cooking apparatus 1 while the main body 10 of the cooking apparatus 1 is installed on the external structure 3. In this case, the bolt body 112 may be provided to sequentially penetrate the installation part S of the external structure 3 and the cabinet 11. For example, the bolt body 112 may penetrate the installation part S and the cabinet 11 so as to direct to the first surface S1 from the second surface S2 of the installation part S. Specifically, the bolt body 112 may pass through the first passing hole 3h of the external structure 3 and the second passing hole 10h of the main body 10.

The bolt body 112 may have screw threads formed on an outer circumferential surface thereof. The screw threads of the bolt body 112 may be male screw threads. The bolt body 112 may be fastened with a mounting nut 140, which will be described later, and the male screw threads of the bolt body 112 may correspond to female screw threads of the mounting nut 140.

The mounting bolt 110 may further include an unthreaded portion 113 in which screw threads are not formed at a lower end of the bolt body 112. The unthreaded portion 113 extends from the lower end of the bolt body 112 and may have a diameter smaller than that of the bolt body 112. For example, the unthreaded portion 113 may be a section of about 5 mm to 10 mm in an up-down direction.

The unthreaded portion 113 may be provided to guide the mounting nut 140 so that the mounting nut 140 is easily fastened when the mounting nut 140 is fastened to the bolt body 112. Also, the unthreaded portion 113 may be provided such that the cooking apparatus 1 is temporarily fixed when the cooking apparatus 1 is installed. For example, a rear surface of the main body 10 of the cooking apparatus 1 may be fixed to the wall W through the mounting plate 14. In this case, in order to install an upper surface (for example, the top plate 11a) of the main body 10 to the upper cabinet 3a in a state in which the rear surface of the main body 10 is fixed to the wall W, the main body 10 needs to be temporarily fixed to prevent the main body 10 from being tilted forward. Before the cooking apparatus 1 is installed actively in the upper cabinet 3a, a separate fastening member (not shown) may be fastened to the unthreaded portion 113 of the mounting bolt 110. Accordingly, during the installation work, a problem such as the cooking apparatus 1 being tilted forward and being damaged or being separated from the installation position may be prevented.

The holder 120 may be provided to adjust a protruding length of the bolt body 112 of the mounting bolt 110 into the main body 10 of the cooking apparatus 1.

Typically, a thickness of an installation part of an external structure (for example, upper storage cabinet) in which a cooking apparatus is installed is not constant. Accordingly, a length of a fixing bolt for fixing the cooking apparatus and the external structure is designed to be long so that the fixing bolt may be used even when the thickness of the external structure is thick. However, when the thickness of the external structure is thin, there is a possibility that the long fixing bolt protrudes deep into a main body of the cooking apparatus and interferes with internal components and the like. When internal components (especially electronic components) accommodated in the main body of the cooking apparatus are damaged by interference with the fixing bolt, the cooking apparatus may not be working properly. For example, a cooking function and/or the hood function of the cooking apparatus may not be performed. Accordingly, it is important to design the fixing bolt protruding into the main body so as not to interfere with the internal components. Therefore, in order to avoid interference between the fixing bolt and the cooking apparatus, a position of the fixing bolt or positions of the internal components may need to be moved. As a result, as arrangement between the fixing bolt and the internal components is considered, a size of the cooking apparatus may increase or a design time and/or installation time may be increased.

According to the present disclosure, the above problems may be solved by the fastening device 100 having the holder 120. Because the holder 120 may adjust the protruding length of the bolt body 112 into the main body 10, interference between the bolt body 112 and the internal parts accommodated in the main body 10 may be prevented.

The holder 120 may include a holder body 121. For example, the holder body 121 may form an exterior of the holder 120.

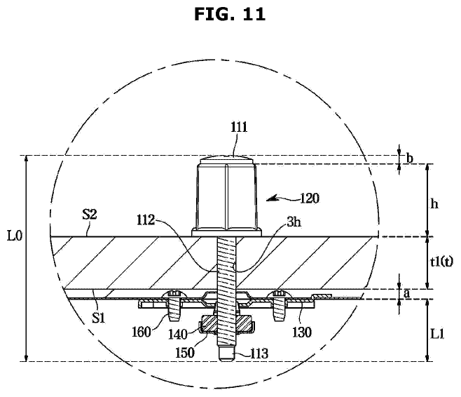

The holder body 121 may be provided to separate the bolt head 111 and the external structure 3 by a predetermined distance. For example, as illustrated in FIG. 11, the holder body 121 may have a predetermined height h, and have one end in contact with the bolt head 111 and the other end in contact with the second surface S2 of the installation part S. Accordingly, the bolt head 111 may be supported by the holder body 121 in a state of being spaced apart from the external structure 3 so that a length L1 of the bolt body 112 protruding into the main body 10 is shortened.

As illustrated in FIGS. 10 and 11, when the thickness t of the external structure 3 is a relatively thin thickness t1, the main body 10 of the cooking apparatus 1 may be fixed to the first surface S1 of the external structure 3 using the fastening device 100 in which the holder 120 is coupled to the mounting bolt 110. In this case, by the predetermined height h of the holder body 121, the bolt head 111 is spaced apart from the external structure 3, the length L1 of the bolt body 112 protruding into the main body 10 may be shortened. For example, in this case, the length L1 of the bolt body 112 protruding into the main body 10 may be a value obtained by subtracting a length b of the bolt head 111 protruding from the holder 120, the height h of the holder 120, the thickness t1(t) of the external structure 3, and a distance a from the first surface S1 of the external structure 3 to an inner surface of the cabinet 11, from an entire length L0 of the mounting bolt 110.

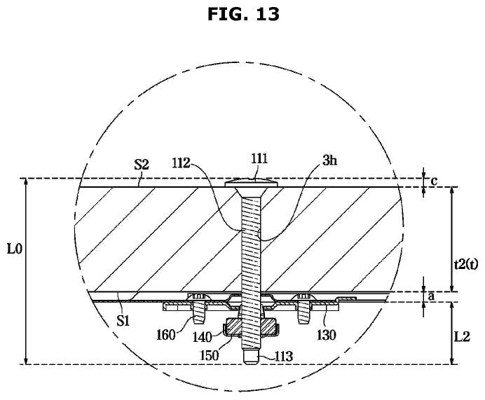

As illustrated in FIGS. 12 and 13, when the thickness t1 of the external structure 3 is a relatively thick thickness t2, the main body 10 of the cooking apparatus 1 may be fixed to the first surface S1 of the external structure 3 using the mounting bolt 110 to which the holder 120 is not coupled. In this case, in order to penetrate the external structure 3 and the cabinet 11, the bolt body 112 needs to be provided to be long, and the cooking apparatus 1 may be fixed to the external structure 3 with only the mounting bolt 110 without the holder. For example, in this case, a length L2 of the bolt body 112 protruding into the main body 10 may be a value obtained by subtracting a length c of the bolt head 111 protruding from the second surface S2 of the external structure 3, the thickness t2(t) of the external structure 3, and the distance a from the first surface S1 of the external structure 3 to the inner surface of the cabinet 11, from the entire length L0 of the mounting bolt 110.

The fastening device 100 may adjust the protruding length of the bolt body 112 into the main body 10 depending on whether the holder 120 is coupled. That is, according to the present disclosure, by determining whether the holder 120 is coupled in consideration of the thickness t of the external structure 3, the cooking apparatus 1 may be easily installed in the external structure 3 and at the same time interference between the bolt body 112 and the internal components may be prevented. As a result, the fastening device 100 may be applied to both cases in which the thickness of the external structure 3 is thick and thin.

The holder body 121 may be provided to support the mounting bolt 110 on the outside of the cooking apparatus 1. Specifically, an upper end of the holder body 121 may support the bolt head 111.

The holder body 121 may include a polygonal shape. This is to allow the holder body 121 to be easily gripped through a tool (e.g., a spanner) in order to prevent the holder 120 from rotating together with the mounting bolt 110 while the mounting bolt 110 is fixed. The drawing illustrates that the holder body 121 includes a hexagonal pillar, but is not limited thereto and may include various polygonal shapes.

The holder 120 may include an elastic support part 123. The elastic support part 123 may be provided inside the holder body 121 to elastically support the bolt body 112. For example, the elastic support part 123 may be bent inwardly from one end of the holder body 121 to extend along an extension direction (i.e., Z direction) of the holder body 121. However, this is only exemplary, and is not limited thereto.

Specifically, the elastic support part 123 may include an elastic support part body 123a, a hollow portion 122, and at least one elastic piece 125.

The elastic support part body 123a may be provided inside the holder body 121. For example, the elastic support part body 123a may extend from the holder body 121.

The hollow portion 122 may be a space formed inside the elastic support part body 123a to accommodate the mounting bolt 110. The hollow portion 122 may include a section in which a diameter of the hollow portion decreases from a first side 122a adjacent to the bolt head 111 toward a second side 122b adjacent to the lower end of the bolt body 112. For example, the above section may be from the first side 122a to a point 122c where a protrusion 125p of the elastic piece 125, which will be described later, is positioned. For example, a diameter d1 of the hollow portion 122 at the first side 122a may be larger than a diameter d3 of the hollow portion 122 at the point 122c. That is, the hollow portion may include a substantially tapered shape. According to this structure, the elastic support part 123 may be provided to elastically support the bolt body 112 while the holder 120 is coupled to the mounting bolt 110.

The elastic piece 125 may be formed to have elasticity by cutting out the elastic support part body 123a. For example, as illustrated in FIGS. 8 and 9, the elastic piece 125 may be formed by a slot 124 provided along a circumference of the elastic support part body 123a. A plurality of the slots 124 and elastic pieces 125 may be provided.

The elastic support part 123 may support the outer circumferential surface of the bolt body 112 with elasticity, and thus may be provided to be deformable within a predetermined range in a radial direction. For example, the elastic piece 125 may spread outward in the radial direction while the holder 120 is coupled to the mounting bolt 110, and may press the outer circumferential surface of the bolt body 112 inward in the radial direction while the holder 120 is completely coupled to the mounting bolt 110. To this end, a predetermined space 128 may be provided between the elastic support part 123 and the holder body 121.

The elastic piece 125 may include the protrusion 125p protruding inward in the radial direction from the elastic support part body 123a. The protrusion 125p may protrude toward the inside of the hollow portion 122. Referring to FIGS. 7 and 8, the protrusion 125p may include a pressing surface 125b and one or more inclined surfaces 125a and 125c.

The pressing surface 125b may be provided to press the outer circumferential surface of the bolt body 112 by coming into contact with the bolt body 112. For example, the elastic support part 123 and the bolt body 112 may be fixed by a frictional force between the outer circumferential surface of the bolt body 112 and the pressing surface 125b.

The inclined surfaces 125a and 125b may include the first inclined surface 125a and/or the second inclined surface 125b. The first inclined surface 125a may be formed to be away from the bolt body 112 from one end of the pressing surface 125b. The second inclined surface 125c may be formed to be away from the bolt body 112 from the other end of the pressing surface 125b. Specifically, the inclined surfaces 125a and 125b may be provided to extend from an upper end or a lower end of the pressing surface 125b so that the holder 120 is easily inserted into or separated from the mounting bolt 110.

Referring to FIG. 7, a length f of the pressing surface 125b may be provided to be longer than a pitch p of the screw threads of the bolt body 112. Only when the length f of the pressing surface 125b is longer than the pitch p of the screw threads, the pressing surface 125b may not enter a groove between the screw threads. In addition, only when the length f of the pressing surface 125b is longer than the pitch p of the screw threads, the pressing surface 125b may not be caught on the screw threads when the holder 120 is coupled or separated.

A bottom surface 121c of the holder body 121 and a bottom surface 125d of the elastic support part 123 may be provided on the same plane. Accordingly, a load applied to the holder 120 may be distributed, and the holder 120 may more stably support the mounting bolt 110 with respect to the external structure 3. For example, the bottom surface 121c of the holder body 121 and the bottom surface 125d of the elastic support part 123 may be provided on an X-Y plane.

In order to reinforce a rigidity of the holder 120, a connection rib 126 may be provided between the holder body 121 and the elastic support part 123.

The holder 120 may be detachably coupled to the mounting bolt 110. As illustrated in FIG. 5, the holder 120 may be coupled to the mounting bolt 110 in an upward direction A. The holder 120 may be provided to be coupled to the mounting bolt 110 by passing through the lower end of the bolt body 112 and being pushed up toward the bolt head 110. The holder 120 is provided not to have a screw thread and thus is not assembled with the mounting bolt 110 by rotation. That is, the holder 120 may be coupled by being vertically pushed up toward the mounting bolt 110 without using a screw thread. For example, in a case in which the length of a bolt is long when assembled by rotation using a screw thread, it may take a lot of time to assemble the bolt and the holder, and productivity may decrease. However, the holder 120 of the present disclosure may be easily coupled to the mounting bolt 110 by a simple manipulation, and thus the assembly time may be reduced.

The holder 120 may also include a protrusion 127 provided to be caught on the bolt head 111 while the holder 120 is coupled to the mounting bolt 110 by pushing up the holder 120 in the upward direction A. The protrusion 127 may include a shape 127a corresponding to a shape of a connection portion 111b connecting the bolt head 111 and the bolt body 112. For example, the protrusion 127 may include the inclined surface 127a.

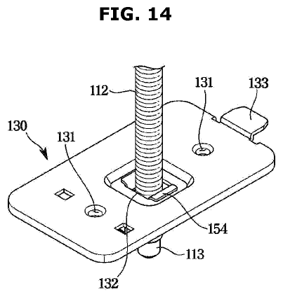

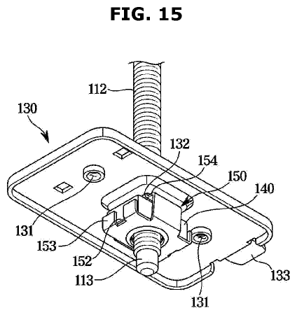

FIG. 14 is a view illustrating a coupling relationship between the mounting bolt, a support bracket, the mounting nut, and a spring holder. FIG. 15 is a bottom perspective view of FIG. 14.

Referring to FIGS. 14 and 15, the fastening device 100 may further include a support bracket 130, the mounting nut 140 and a spring holder 150.

The support bracket 130 may be provided such that the bolt body 112 of the mounting bolt 110 penetrates therethrough. Specifically, the support bracket 130 is disposed adjacent to the inner surface of the outer case 11, and the bolt body 112 that has penetrated the installation part S of the external structure 3 and the outer case 11 may penetrate the support bracket 130. For example, the support bracket 130 may include a plate shape.

The support bracket 130 may include a first hole 132 through which the bolt body 112 passes. The support bracket 130 may also include a second hole 131 such that a separate fastening member 160 (e.g., a bolt) may be fastened thereto. A plurality of the second holes 131 may be provided. The support bracket 130 may include a hooking part 133 to be coupled with the outer case 11. For example, the hooking part 133 may be provided to be fitted into the outer case 11. However, the present disclosure is not limited thereto.

The mounting nut 140 may be provided to be coupled with the bolt body 112 penetrated through the support bracket 130. The mounting nut 140 may include a shape corresponding to the bolt body 112. For example, the mounting nut 140 may have the female screw threads corresponding the male screw threads of the bolt body 112.

The spring holder 150 may be provided to support the mounting nut 140 by being coupled with the support bracket 130. For example, the spring holder 150 may support the mounting nut 140 with an elastic force.

The spring holder 150 may include a coupling part 154 coupled to the support bracket 130. For example, the coupling part 154 may be provided to be caught on the first hole 131 by being bent by a predetermined portion. The spring holder 150 may include a seating part 152 provided to seat the mounting nut 140, and a seating extension part 153 provided to extend from the mounting part 152 to cover a side surface of the mounting nut 140, in order to stably support the mounting nut 140. The spring holder 150 may include a spring holder hole 151 such that the bolt body 112 passed through the mounting nut 140 penetrates into the main body.

Hereinafter, a fastening device 200 according to another embodiment of the present disclosure will be described. Like reference numbers or signs represent parts or components that perform substantially the same functions, and thus a detailed description of these will be omitted.

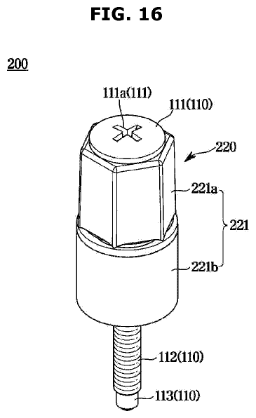

Compared to the aforementioned fastening device 100, the fastening device 200 may have a two-stage structure. For example, the fastening device 200 may have a structure that further includes a second holder body 221b, which will be described later, based on the fastening device 100 as a basic structure. Hereinafter, this will be described with reference to FIGS. 16 to 24.

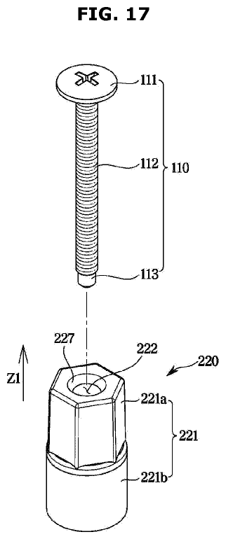

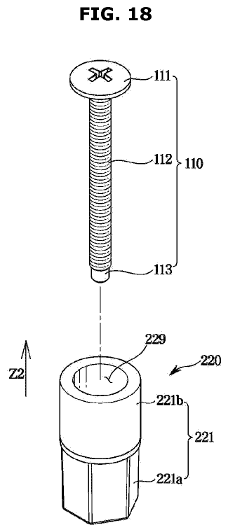

FIG. 16 is a perspective view of a fastening device according to another embodiment of the present disclosure. FIG. 17 is a view illustrating that a holder according to another embodiment of the present disclosure is being coupled to a mounting bolt in a first state. FIG. 18 is a view illustrating that the holder according to another embodiment of the present disclosure is being coupled to the mounting bolt in a second state.

A holder 220 may be provided to adjust a length in which the bolt body 112 of the mounting bolt 110 protrudes into the main body 10 of the cooking apparatus 1. As described above, the holder 220 may prevent the bolt body 112 from interfering with the internal components accommodated in the main body 10.

The holder 220 may include a holder body 221. The holder body 221 may be provided to separate the bolt head 111 and the external structure 3. The holder body 221 may be provided to support the mounting bolt 110 from the outside of the cooking apparatus 1.

The holder body 221 may include a first holder body 221a and a second holder body 221b extending from the first holder body 221a. While the mounting bolt 110 and the holder 220 are coupled, the bolt body 112 of the mounting bolt 110 may be accommodated in the holder body 221 of the holder 220. For example, the first holder body 221a may include a hollow portion 222, and the second holder body 221b may include an accommodation portion 229. The hollow portion 222 and the accommodation portion 229 may communicate with each other. The accommodation portion 229 may have a larger diameter than the hollow portion 222.

The first holder body 221a may have a first height h1, and the second holder body 221b may have a second height h2. The first height h1 and the second height h2 may be the same or different. For example, the first height h1 and the second height h2 may be provided in various lengths depending on a kitchen environment in which the cooking apparatus 1 is installed, the thickness t of the external structure 3, and the like.

The holder 220 may be detachably coupled to the mounting bolt 110. The holder 220 may be coupled to the mounting bolt 110 in upward directions Z1 and Z2. The holder 220 may be provided to be coupled to the mounting bolt 110 by passing through the lower end of the bolt body 112 and being pushed up toward the bolt head 110. The holder 220 is provided not to have a screw thread and thus may be coupled to the mounting bolt 110 by being vertically pushed up toward the mounting bolt 110. Accordingly, the assembly time may be reduced.

The holder 220 may be coupled to the mounting bolt 110 in a first state (see FIG. 17) or a second state (see FIG. 18). For example, the first state and the second state of the holder 220 may be upside down inverted states.

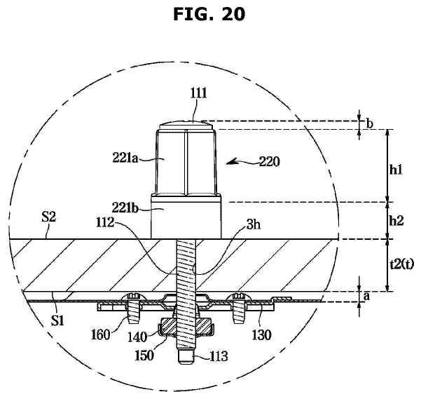

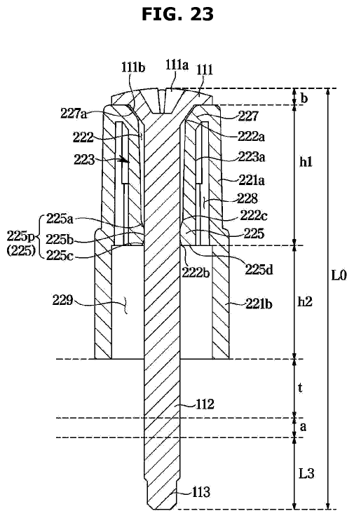

Referring to FIG. 17, the first state of the holder 220 may be a state in which the first holder body 221a is positioned on an upper side and the second holder body 221b is positioned on a lower side. The holder 220 may pass through the lower end of the bolt body 112 in the first state and be pushed up toward the bolt head 110 (see Z1 in FIG. 17). Also, as illustrated in FIGS. 20 and 23, while the holder 220 is coupled to the mounting bolt 110 in the first state, the first holder body 221a may be adjacent to the bolt head 111. An upper surface of the first holder body 221a may be provided to support the bolt head 111. The second holder body 221b may be adjacent to the second surface S2 of the external structure 3.

The first holder body 221a may include a protrusion 227 provided to be caught on the bolt head 111 while the holder 220 is pushed up in the upward direction Z1 in the first state and coupled to the mounting bolt 110. For example, the protrusion 227 may include a shape 227a corresponding to the connection portion 111b of the mounting bolt 110. For example, the protrusion 227 may include the inclined surface 227a.

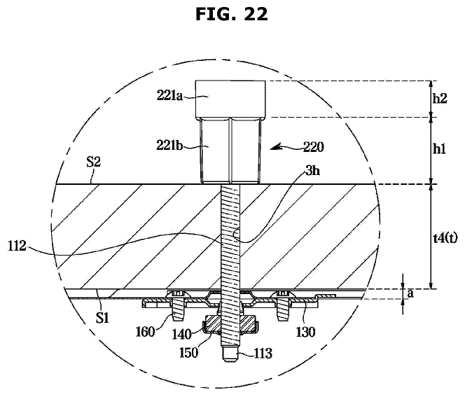

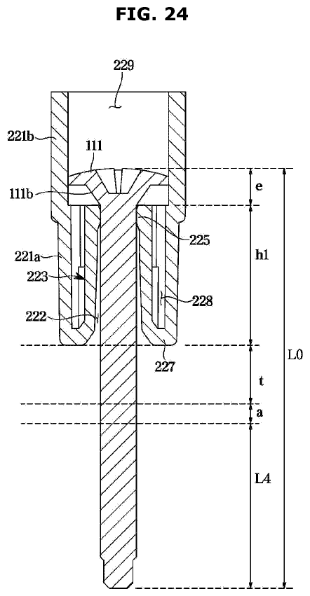

Referring to FIG. 18, the second state of the holder 220 may be a state in which the second holder body 221b is positioned on the upper side and the first holder body 221a is positioned on the lower side. The holder 220 may pass through the lower end of the bolt body 112 in the second state and be pushed up toward the bolt head 110 (see Z2 in FIG. 18). Also, as illustrated in FIGS. 22 and 24, while the holder 220 is coupled to the mounting bolt 110 in the second state, the bolt head 111 may be accommodated in the accommodation portion 229 of the second holder body 221b. The first holder body 221a may be adjacent to the second surface S2 of the external structure 3.

The holder 220 may adjust the protruding length of the bolt body 112 into the main body 10 of the cooking apparatus 1 depending on whether the holder 220 is coupled to the mounting bolt 110 in the first state or the second state. Hereinafter, while the holder 220 is coupled to the mounting bolt 110 in the first state, it may be referred to as a ‘first coupled state’ of the fastening device 200. While the holder 220 is coupled to the mounting bolt 110 in the second state, it may be referred to as a ‘second coupled state’ of the fastening device 200.

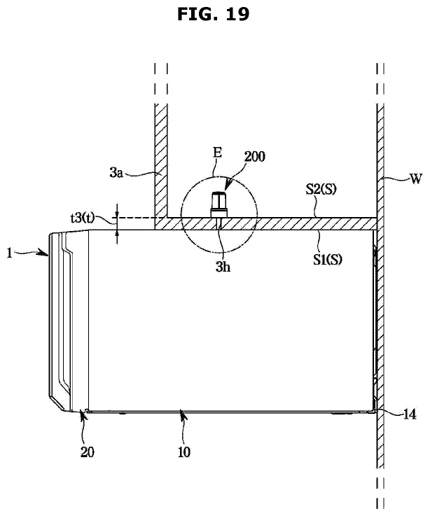

As illustrated in FIGS. 19 and 20, when the thickness t of the external structure 3 is a relatively thin thickness t3, the fastening device 200 may fix the main body 10 of the cooking apparatus 1 to the external structure 3 in a first coupled state. In this case, by the height h1 of the first holder body 221a and the height h2 of the second holder body 221b, the bolt head 111 may be spaced apart from the external structure 3. When the thickness t of the external structure 3 is thin, interference between the mounting bolt 110 and the internal components of the cooking apparatus 1 may be a problem, and thus the holder 220 may separate the bolt head 111 and the external structure 3 as much as possible by using an entire height (h1+h2) of the holder body 221.

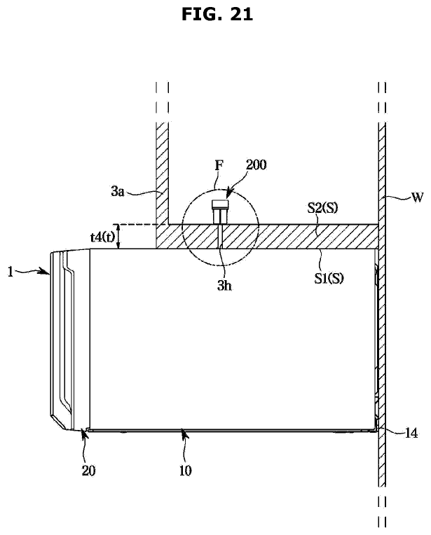

As illustrated in FIGS. 21 and 22, when the thickness t of the external structure 3 is a relatively thick thickness t4, the fastening device 200 may fix the main body 10 of the cooking apparatus 1 to the external structure 3 in a second coupled state. In this case, by the height h1 of the first holder body 221a and a length e of the mounting bolt 110 accommodated in the accommodation portion 229 of the second holder body 221b, the bolt head 111 may be spaced apart from the external structure 3. When the thickness t of the external structure 3 is thick, the bolt body 112 needs to be designed to be long for fixing the external structure 3 and the cooking apparatus 1, and thus the holder 220 may separate the bolt head 111 and the external structure 3 by using a height (e+h1) smaller than the entire height (h1+h2) of the holder body 221.

The fastening device 200 may adjust the protruding length of the bolt body 112 into the main body 10 depending on the first coupled state or the second coupled state. That is, by changing the state (first state or second state) of the holder 220 in consideration of the thickness t of the external structure 3, the cooking apparatus 1 may be easily installed on the external structure 3, and at the same time interference between the bolt body 112 and the internal components may be prevented. As a result, the fastening device 200 may be applied to both the case in which the thickness of the external structure 3 is thick and thin.

As described above, the fastening device 200 may adjust the protruding length of the bolt body 112 into the main body 10 as the holder 220 is inverted vertically and fastened to the mounting bolt 110. Like the fastening device 100 in the above-described embodiment, the cooking apparatus 1 may be fixed to the external structure 3 by only the mounting bolt 110 without coupling of the holder 220 (see FIGS. 12 and 13). For example, when the thickness t of the external structure is relatively thin, the fastening device 200 may be used in the first coupled state. When the thickness t of the external structure is relatively thick, the fastening device 200 may be used in the second coupled state. When the thickness t of the external structure is relatively thick, only the mounting bolt 110 may be used without the holder 220.

The protruding length of the bolt body 112 into the main body 10 will be described below with reference to FIGS. 23 and 24. Specifically, assuming that the thickness t of the external structure 3 is the same, a comparison between a protruding length L3 of the bolt body 112 when the fastening device 200 is in the first coupled state and a protruding length L4 of the bolt body 112 when the fastening device 200 is in the second coupled state will be described below.

FIG. 23 illustrates a cross section of the fastening device 200 in the first coupled state. For example, the length L3 of the bolt body 112 protruding into the main body 10 may be a value obtained by subtracting the length b of the bolt head 111 protruding from the holder 220, the height h1 of the first holder body 221a, the height h2 of the second holder body 221b, the thickness t of the outer structure 3, and the distance a from the first surface S1 of the outer structure 3 to the inner surface of the cabinet 11, from the entire length L0 of the mounting bolt 110. That is, L3=L0−b−h1−h2−t−a may be satisfied. Hereinafter, for convenience, when the cooking apparatus 1 is fastened to the external structure 3, the length L3 of the bolt body 112 protruding into the main body 10 when the fastening device 200 is in the first coupled state may be referred to as the first length L3.

FIG. 24 illustrates a cross section of the fastening device 200 in the second coupled state. For example, the length L4 of the bolt body 112 protruding into the main body 10 may be a value obtained by subtracting the length e of the mounting bolt 110 accommodated in the accommodation portion 229 of the second holder body 221b, the height h1 of the first holder body 221a, the thickness t of the external structure 3, and the distance a from the first surface S1 of the outer structure 3 to the inner surface of the cabinet 11, from the entire length L0 of the mounting bolt 110. That is, L4=L0−e−h1−t−a may be satisfied. Hereinafter, for convenience, when the cooking apparatus 1 is fastened to the external structure 3, the length L4 of the bolt body 112 protruding into the main body 10 when the fastening device 200 is in the second coupled state may be referred to as the second length L4.

For example, the comparison between the first length L3 and the second length L4 is as follows. When the values h1, t, and a subtracted equally in both the cases from the entire length L0 are excluded, the case of the first length L3 may be a value obtained by further subtracting the length b of the bolt head 111 protruding from the holder 220 and the height h2 of the second holder body 221b. The case of the second length L4 may be a value obtained by further subtracting the length e of the mounting bolt 110 accommodated in the accommodation portion 229 of the second holder body 221b. In this case, the length e of the mounting bolt 110 accommodated in the accommodation portion 229 of the second holder body 221b is inevitably equal to or smaller than the height h2 of the second holder body 221b. Therefore, assuming that the thickness t of the external structure 3 is the same, the protruding length L3 of the bolt body 112 when the fastening device 200 is in the first coupled state is smaller than the protruding length L4 of the bolt body 112 when the fastening device 200 is in the second coupled state.

The holder body 221 may include a polygonal shape. This is to allow the holder body 221 to be easily gripped through a tool (e.g., a spanner) in order to prevent the holder 220 from rotating together with the mounting bolt 110 while the mounting bolt 110 is fixed. The drawing illustrates that the first holder body 221a includes a hexagonal pillar, but is not limited thereto and may include various polygonal shapes.

Referring to FIGS. 23 and 24, the holder 220 may include an elastic support part 223. The elastic support part 223 may perform substantially the same function as the elastic support part 123 described above.

The elastic support part 223 may be provided inside the holder body 221 to elastically support the bolt body 112. Specifically, the elastic support part 223 may be provided inside the first holder body 221a. For example, the elastic support part 123 may be bent inwardly from one end of the first holder body 221a to extend along an extension direction (i.e., Z direction) of the holder body 221. However, this is only exemplary, and is not limited thereto.

Specifically, the elastic support part 223 may include an elastic support part body 223a, a hollow portion 222, and at least one elastic piece 225.

The elastic support part body 223a may be provided inside the holder body 221. For example, the elastic support part body 223a may extend from the first holder body 221a.

The hollow portion 222 may be a space formed inside the elastic support part body 223a to accommodate the mounting bolt 110. The hollow portion 222 may include a section in which a diameter of the hollow portion decreases from a first side 222a adjacent to the bolt head 111 toward a second side 222b adjacent to the lower end of the bolt body 112. For example, the above section may be from the first side 222a to a point 222c where a protrusion 225p of the elastic piece 225, which will be described later, is positioned. For example, a diameter of the hollow portion 222 at the first side 222a may be larger than a diameter of the hollow portion 222 at the point 222c. That is, the hollow portion may include a substantially tapered shape. According to this structure, the elastic support part 223 may be provided to elastically support the bolt body 112 while the holder 220 is coupled to the mounting bolt 110.

The elastic piece 225 may be formed to have elasticity by cutting out the elastic support part body 223a. For example, as illustrated in FIGS. 8 and 9, the elastic piece 225 may be formed by a slot 224 provided along a circumference of the elastic support part body 223a. A plurality of the slots 224 and elastic pieces 225 may be provided.

The elastic support part 223 may support the outer circumferential surface of the bolt body 112 with elasticity, and thus may be provided to be deformable within a predetermined range in the radial direction. For example, the elastic piece 225 may spread outward in the radial direction when the holder 220 is coupled to the mounting bolt 110, and may press the outer circumferential surface of the bolt body 112 inward in the radial direction when the holder 220 is completely coupled to the mounting bolt 110. To this end, a predetermined space 228 may be provided between the elastic support part 223 and the holder body 221.

The elastic piece 225 may include the protrusion 225p protruding inward in the radial direction from the elastic support part body 223a. The protrusion 225p may protrude toward the inside of the hollow portion 222. Referring to FIGS. 7 and 8, the protrusion 225p may include a pressing surface 225b and one or more inclined surfaces 225a and 225c.

The pressing surface 225b may be provided to press the outer circumferential surface of the bolt body 112 by coming into contact with the bolt body 112. For example, the elastic support part 223 and the bolt body 112 may be fixed by a frictional force between the outer circumferential surface of the bolt body 112 and the pressing surface 225b.

The inclined surfaces 225a and 225b may include the first inclined surface 225a and/or the second inclined surface 225b. The first inclined surface 225a may be formed to be away from the bolt body 112 from one end of the pressing surface 225b. The second inclined surface 225c may be formed to be away from the bolt body 112 from the other end of the pressing surface 225b. Specifically, the inclined surfaces 225a and 225b may be provided to extend from an upper end or a lower end of the pressing surface 225b so that the holder 220 is easily inserted into or separated from the mounting bolt 110.

The length f of the pressing surface 225b may be provided to be longer than the pitch p of the screw threads of the bolt body 112. Only when the length f of the pressing surface 225b is longer than the pitch p of the screw threads, the pressing surface 225b may not enter a groove between the screw threads. In addition, only when the length f of the pressing surface 225b is longer than the pitch p of the screw threads, the pressing surface 225b may not be caught on the screw threads when the holder 220 is coupled or separated.

The foregoing has illustrated and described specific embodiments. However, it should be understood by those of skilled in the art that the present disclosure is not limited to the above-described embodiments, and various changes and modifications may be made without departing from the technical idea of the present disclosure described in the following claims.

What is claimed:

1. A cooking apparatus comprising:
a main body having a cooking chamber inside the main body;
a mounting bolt including:
a bolt head, and
a bolt body extending from the bolt head and configured to sequentially penetrate an external structure to which the cooking apparatus is to be mounted and then the main body; and
a holder detachably coupleable to the mounting bolt so that, when the holder is coupled to the mounting bolt with the bolt body penetrating the external structure and the main body, the holder is outside of the main body and supports the mounting bolt,
wherein the holder includes:
a holder body configured to, when the holder is coupled to the mounting bolt with the bolt body penetrating the external structure and the main body, separate the bolt head and the external structure and, when separating the bolt head and the external structure, to adjust a protruding length of the bolt body into the main body, and
an elastic support part inside the holder body and configured to, when the holder is coupled to the mounting bolt, elastically support the bolt body.

2. The cooking apparatus according to claim 1, wherein the elastic support part of the holder includes:
an elastic support part body,
a hollow portion formed inside the elastic support part body to accommodate the mounting bolt when the holder is coupled to the mounting bolt; and
a plurality of elastic pieces formed to have elasticity by cutting out the elastic support part body.

3. The cooking apparatus according to claim 2, wherein each of the plurality of elastic pieces includes:
a pressing surface configured to press an outer circumferential surface of the bolt body when the holder is coupled to the mounting bolt,
a first inclined surface formed to be away from the bolt body from one end of the pressing surface when the holder is coupled to the mounting bolt, and
a second inclined surface formed to be away from the bolt body from an other end of the pressing surface when the holder is coupled to the mounting bolt.

4. The cooking apparatus according to claim 1, wherein
the holder body is a first holder body, and
the holder further comprises a second holder body extending from the first holder body and having an accommodation portion therein to accommodate the mounting bolt when the holder is coupled to the mounting bolt.

5. The cooking apparatus according to claim 1, wherein
the holder is configured to be detachably coupleable to the mounting bolt by passing through a lower end of the bolt body and being pushed up toward the bolt head.

6. The cooking apparatus according to claim 4, wherein
the holder is coupleable to the mounting bolt in a first state or a second state,
the first holder body is adjacent to the bolt head while the holder is coupled to the mounting bolt in the first state, and
the bolt head is accommodated in the accommodation portion of the second holder body while the holder is coupled to the mounting bolt in the second state.

7. The cooking apparatus according to claim 6, wherein
the protruding length of the bolt body into the main body while the holder is coupled to the mounting bolt in the first state is smaller than the protruding length of the bolt body into the main body while the holder is coupled to the mounting bolt in the second state.

8. The cooking apparatus according to claim 6, wherein
the bolt head is configured to be supported by an upper surface of the first holder body while the holder is coupled to the mounting bolt in the first state, and
the bolt head is configured to be accommodated in the accommodation portion of the second holder body while the holder is coupled to the mounting bolt in the second state.

9. The cooking apparatus according to claim 3, wherein
the bolt body has screw threads, and
a length of the pressing surface is longer than a pitch of the screw threads of the bolt body.

10. The cooking apparatus according to claim 1, wherein
the bolt body has screw threads, and
the mounting bolt further includes an unthreaded portion extending from a lower end of the bolt body, having a diameter smaller than that of the bolt body.

11. The cooking apparatus according to claim 1, wherein
a bottom surface of the holder body and a bottom surface of the elastic support part are on a same plane so that, when the holder is coupled to the mounting bolt with the bolt body penetrating the external structure and the main body, the holder stably supports the mounting bolt with respect to the external structure.

12. The cooking apparatus according to claim 1, further comprising:
a base plate configured to draw air from a lower portion of the main body; and
a filter configured to filter out foreign substances in the air drawn from the base plate.

13. The cooking apparatus according to claim 2, wherein
the hollow portion includes a section in which, when the holder is coupled to the mounting bolt, a diameter of the hollow portion decreases from a first side adjacent to the bolt head toward a second side adjacent to a lower end of the bolt body.

14. The cooking apparatus according to claim 1, further comprising:
a support bracket positionable adjacent to an inner surface of the main body so that, when the support bracket is positioned adjacent to the inner surface of the main body and the bolt body penetrates the main body, the bolt body penetrates through the support bracket;
a mounting nut coupleable with the bolt body penetrated through the support bracket; and
a spring holder coupled to the support bracket to support the mounting nut.
